(19) United States
(12) Patent Application Publication
(10) Pub. No.: US 2008/0137880 A1
(43) Pub. Date: Jun. 12, 2008

(54) Wireless audio speaker system

(75) Inventors: Stephen B. Mills, Atkinson, NH (US); Vian W.Y Li, Honk Kong (HK)

Correspondence Address: Grossman Tucker Perreault & Pfleger,PLLC, 55 SOUTH COMMERCIAL STREET, MANCHESTER, NH, 03101, US

(73) Assignee: Brookstone Purchasing, Inc., Merrimack, NH (US)

(21) Appl. No.: 11/636,808

(22) Filed: Dec. 11, 2006

(51) Int. Cl. H04B 5/00

(52) U.S. Cl. 381/79

(57) ABSTRACT

A speaker system employs a first device and a second device where one of the first device and the second device is a speaker. The first device has a supporting surface, from which a positioning element protrudes and forms a distal end. The positioning element tapers from the supporting surface to a smaller dimension at the distal end. The second device has a cavity receiving the positioning element. In one embodiment, the first device has a first electrical contact positioned adjacent to the positioning element and the second device has a second electrical contact engaging the first electrical contact. In another embodiment, the first and second device are rotationally repositionable relative to one another, and an electrical connection is created between the first device and the second device when the cavity receives the positioning element at more than one relative rotational position between the first device and the second device.

### BACKGROUND OF THE INVENTION

1. Field of the Invention

This invention relates generally to a speaker system, and more particularly, to a system for delivering power to a wireless speaker system.

2. Description of Related Art

A wide range of electronic devices is available to present media content. Such devices include radio receivers, television systems, DVD players, CD players, digital or magnetic tape players, video game consoles, personal computers with media players, and portable personal audio players such as MP3 players.

These electronic media devices generally work by processing data or signals they receive from various media. For example, a radio receiver receives and processes broadcast signals transmitted from a broadcast tower or satellite; a CD player reads and processes the digital data on a CD; or an MP3 player reads and processes digital data stored on a memory device. An output device, such as a television monitor or a set of speakers, is required to present the video or audio that result from processing the data or signals. Such output devices may be integrated with the electronic media device or may be external components that are connected to the electronic media device. Traditionally, an external output device is connected to the electronic media device via wires or cables, such as speaker wires or coaxial cables.

In large part, the media content presented through electronic media devices contains some audio component. For instance, although a movie presented through a DVD player may present visual content, the visual content is usually accompanied by an audio soundtrack. As such, consumers often require external speaker systems as output devices to present the audio component of the media content. Despite the growth in the market for electronic media and the devices that present electronic media, consumers continue to use traditional speakers systems that require external wire connections to the electronic media device. External wire connections are difficult to manage and organize, particularly when there are many devices and many wire connections, as is the case with even simple entertainment systems. In addition, external speaker wire connections may limit the orientation and position of a speaker with respect to the position of a listener. A speaker generally directs sound in a specific direction, but the wires leading from the speaker may prevent the speaker from being easily oriented, or turned, to direct sound toward a desired location. Furthermore, external wire connections limit the portability of speakers. In view of the growth in the popularity of portable electronic media devices, limited portability is often considered to be a significant disadvantage.

### SUMMARY OF THE INVENTION

In view of the problems described previously, embodiments of the present invention provide a system that enables power and/or audio signals to be transmitted to a speaker without connecting external wires or cables to the speaker. In particular, embodiments of the present invention provide a system for connecting a speaker to a power source without connecting a power cord to the speaker. Moreover, embodiments of the present invention provide a system for connecting a speaker to a power source while allowing the speaker to be rotated to face in any direction. Advantageously, embodiments of the present invention also make speakers easily portable.

In an exemplary embodiment, a speaker system employs a first device and a second device, where one device is a speaker and the other device is a power delivery base. The first device has a supporting surface, where a positioning element protrudes from the supporting surface and forms a distal end. The positioning element tapers from the supporting surface to a smaller dimension at the distal end. The second device has a cavity receiving the positioning element. The first device has a first electrical contact positioned adjacent to the positioning element and the second device has a second electrical contact engaging the first electrical contact.

In another embodiment, a speaker system employs a first device and a second device, where one device is a speaker and the other device is a power delivery base. The first device has a supporting surface, where a positioning element protrudes from the supporting surface and forms a distal end. The positioning element tapers from the supporting surface to a smaller dimension at the distal end. The second device has a cavity receiving the positioning element. The first and second device are rotationally repositionable relative to one another, and an electrical connection is created between the first device and the second device when the cavity receives the positioning element at more than one relative rotational position between the first device and the second device.

In the embodiments above, the positioning element may be frustaconical, or frustum-shaped, to facilitate mating of the first device and the second device. In addition, the speaker may be a wireless speaker with a rechargeable power storage device which is recharged though electrical connections between the first and second devices. As such, the speaker operates without any external wire connections.

These and other aspects of the present invention will become more apparent from the following detailed description of the preferred embodiments of the present invention when viewed in conjunction with the accompanying drawings.

### BRIEF DESCRIPTION OF THE DRAWINGS

FIG. 1 illustrates an exemplary embodiment of the present invention, including a speaker and an electrical power delivery base.

FIG. 2A illustrates a bottom view of the speaker for the exemplary embodiment shown in FIG. 1.

FIG. 2B illustrates a cross-sectional view of the speaker for the exemplary embodiment shown in FIG. 1.

FIG. 3A illustrates a top view of the electrical power delivery base for the exemplary embodiment shown in FIG. 1.

FIG. 3B illustrates an exploded view of the electrical power delivery base for the exemplary embodiment shown in FIG. 1.

FIG. 3C illustrates a cross-sectional view of the electrical power delivery base for the exemplary embodiment shown in FIG. 1.

FIG. 4 illustrates a detailed cross-sectional view of the lower section of the speaker and the electrical power delivery base for the exemplary embodiment shown in FIG. 1.

### DETAILED DESCRIPTION

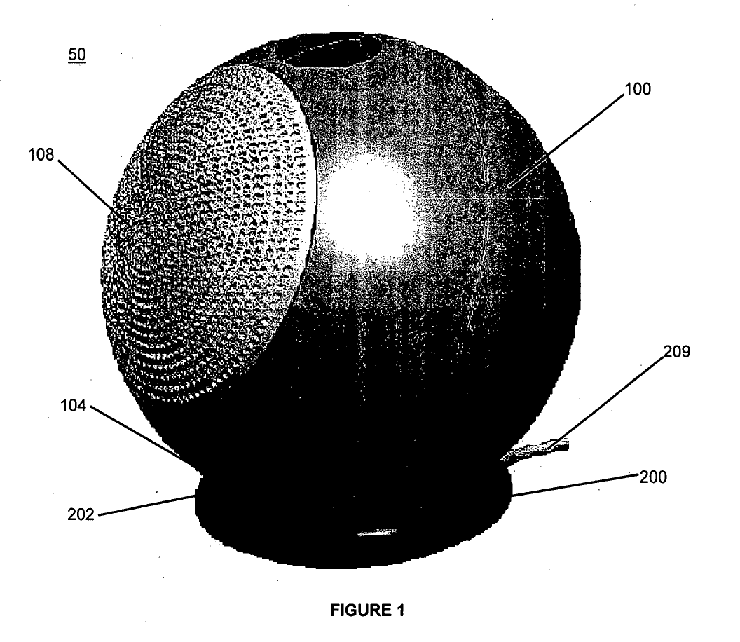

Referring to FIG. 1, an exemplary embodiment of the present invention is generally illustrated as a speaker system 50 which includes a speaker 100 and an electrical power delivery base 200. In particular, the speaker 100 may be a rechargeable wireless speaker, which is recharged by electricity delivered from the electrical power delivery base 200. The speaker 100 receives wireless signal transmissions from an audio signal producing device. An audio signal producing device produces an audio signal that can be converted into sound, but the audio signal producing device requires an output device, such as a speaker, to convert the signal into sound. Such audio producing devices may include, but are not limited to, radio receivers, television systems, DVD players, CD players, digital or magnetic tape players, video game consoles, personal computers with media players, and portable personal audio players such as MP3 players. The speaker 100 converts the wireless signals it receives from these devices into sound, or acoustical energy, which is then transmitted through the speaker grill 108 to the area surrounding the speaker 100.

Because the speaker 100 receives wireless signals, it is not connected to an audio producing device by conventional speaker wires that deliver audio signals and electrical power to speakers. Therefore, the base 200 is provided to deliver the power the speaker 100 requires to receive and convert audio signals into sound. The electrical power delivery base 200 in turn may receive electricity through power input 209 from an external source, such as electricity provided through a standard electrical power outlet. In addition, the speaker 100 has a rechargeable power storage device, such as a rechargeable battery, that allows the speaker 100 to receive and store power from the base 200 repeatedly. With this storage device, the speaker 100 can operate even though it is disconnected from the base 200. Employing a rechargeable power storage device and a base 200 to connect the speaker 100 to an external power source enables the speaker 100 to be operated without external power cords or disposable batteries. In addition, the speaker 100 is easily portable, because it can be used without an external physical connection to a power supply and/or an audio producing device.

Although the exemplary embodiments described herein refer to the speaker system 50, it is understood that the application of the present invention is not limited to a speaker system and may be applied generally to the delivery of power to any electrical device. In addition, the speaker, or electrical device, is not limited to those employing a rechargeable power storage device. For instance, the speaker, or electrical device, may receive power when it is only connected to the base 200. The advantages of a speaker system according to the present invention, with or without a rechargeable power storage device, are described herein.

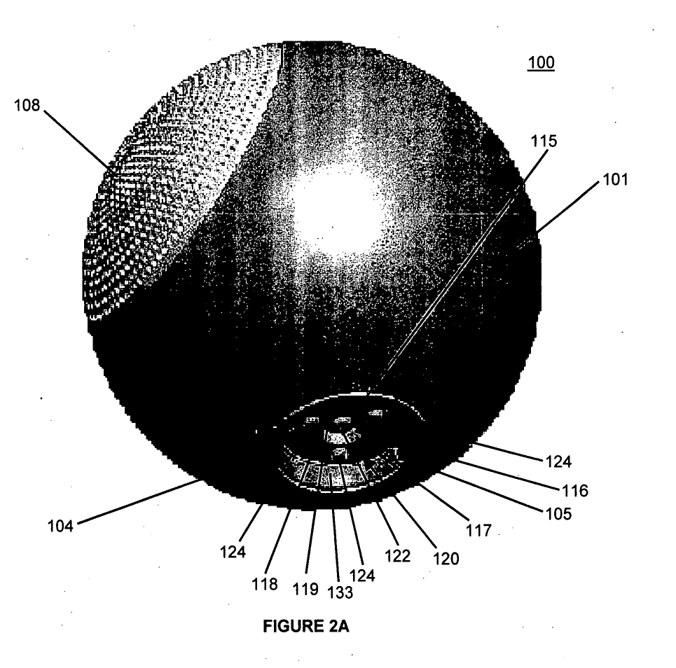

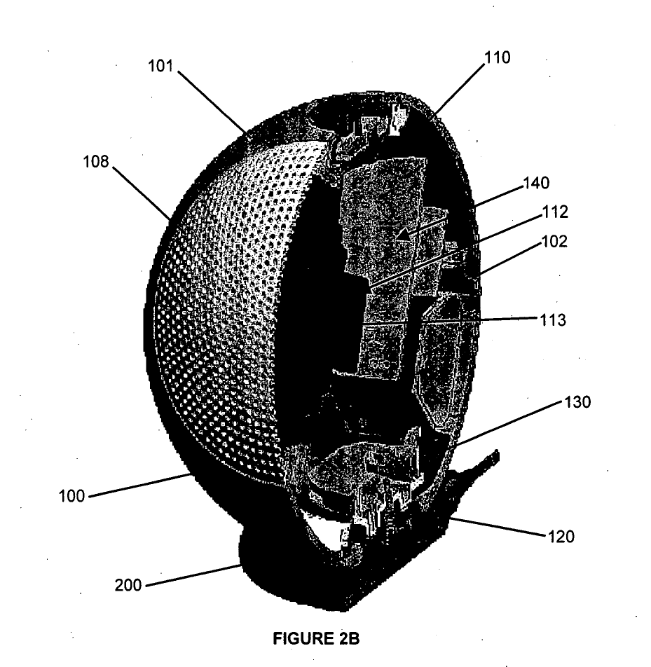

As shown further in FIG. 1, the speaker bottom 104 of the speaker 100 is situated on a reciprocally engaging and/or supporting, top surface 202 of the base 200. When the speaker 100 is situated on the base 200, the speaker is in a recharging position where power is delivered from the base 200 to the speaker 100. FIG. 2A illustrates a bottom view of the speaker 100. Although the speaker 100 may have various shapes, the speaker 100 in FIG. 2A generally has a spherical body 101 with the speaker grill 108. Although a substantial portion of the outer surface of the speaker body 101 is generally spherical, a flat section 105 is defined on a bottom surface 104 of the speaker body 101. As shown in FIG. 2A, the flat section 105 is an annular surface, but may be any appropriate shape that permits the speaker 100 to be placed on any flat surface.

As further shown in FIG. 2A, the speaker 100 has an electrical contact area 120 positioned on the speaker bottom 104. A receiving cavity 115 with a cavity opening 117 is in turn centrally positioned at the electrical contact area 120. The speaker 100 generally receives power from the electrical power delivery base 200 through positive and negative electrical contacts, or terminals, which are arranged on the electrical contact area 120. As illustrated in FIG. 2A, a positive electrical contact 122 for the speaker 100 is centrally positioned in the electrical contact area 120. In addition, a plurality of negative electrical contacts 124 are positioned and equally spaced along an annular, or ring-shaped, surface 118. The annular surface 118 is positioned on the electrical contact area 120 around the periphery of the positive electrical terminal 122. It is understood that the arrangement of the positive and negative terminals are not limited to the arrangements described herein. For instance, the negative terminal may be centrally positioned while positive terminals are positioned along the periphery of the negative terminal. Further details regarding the delivery of electricity to the positive electrical terminal 122 and negative electrical terminal 124 are provided hereinbelow.

FIG. 2B illustrates a cross-sectional view of the speaker 100. The speaker body 101 is defined by a speaker body wall 102 that defines a speaker interior cavity 110. The speaker interior cavity 110 houses a signal conversion assembly 140 necessary for receiving and converting the wireless audio signals from an audio signal producing device into sound which is delivered through the speaker grill 108. In particular, interior signal conversion assembly 140 includes a speaker driver 112. The speaker driver 112 is an active element of the speaker 100 that creates compressions and rarefactions in the air through a diaphragm 113. The speaker driver 112 produces the appropriate audio frequency range for the sound transmitted through the speaker grill 108. Although the signal conversion assembly 140 shown in FIG. 2B shows one speaker driver 112, the signal conversion assembly 140 may have any combination of speaker drivers, including a tweeter, midrange, or woofer. In general, the speaker 100 may receive and convert the wireless audio signals into acoustical energy according to techniques known to those of ordinary skill in the art; thus, the details regarding such techniques are not discussed herein.

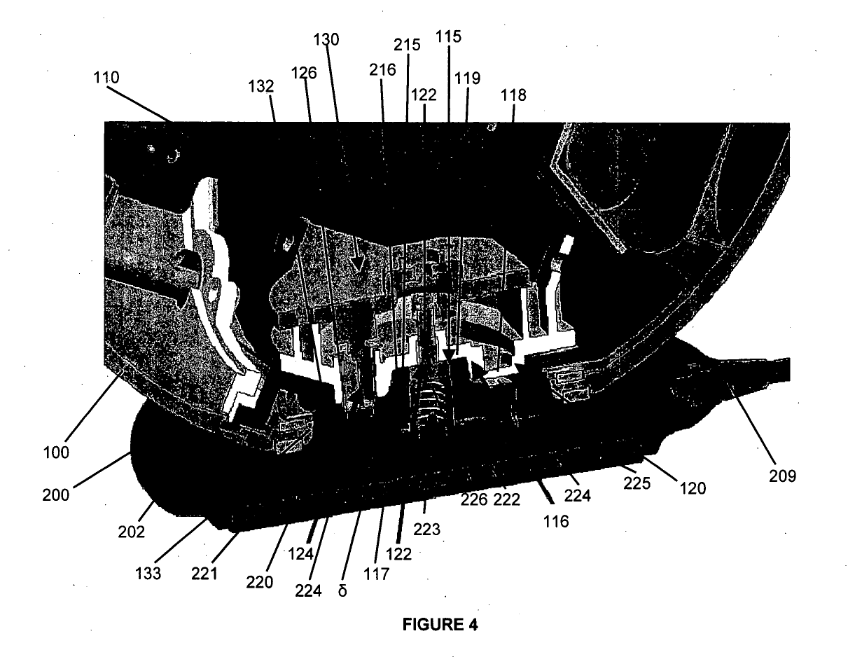

As further illustrated in FIG. 2B, an electrical power assembly 130 is positioned at the bottom of the speaker interior cavity 110. As also shown in FIG. 4, the bottom section of the electrical power assembly 130 includes the electrical contact area 120. Thus, the electrical power assembly 130 passes through the speaker body wall 102 to make the electrical power assembly 130 externally accessible for receiving power from the electrical power delivery base 200. As further illustrated in FIG. 4, the positive electrical terminal 122 is a plug-shaped column that extends from the electrical power assembly 130 in the speaker cavity 110 downwardly to the electrical contact area 120. The plug-shaped column has a larger area at its lower end to receive current from the base 200 and conduct the current into the speaker 100. The negative electrical terminals 124 are substantially cylindrical bodies that extend from the electrical power assembly 130 in the speaker cavity 110 downwardly through the annular surface 118 to the electrical contact area 120, where it conducts current from the speaker 100 to the base 200.

As described previously, the speaker 100 has a rechargeable power storage device. The electrical power assembly 130 receives power from the base 200 and delivers the power to the rechargeable power storage device (not shown) which is also positioned within the speaker interior cavity 110. The rechargeable storage device may employ chemically-based energy storage. In general, the rechargeable storage device converts the electricity from the electrical power assembly 130 to a form of stored energy according to techniques known to those of ordinary skill in the art; thus, the details regarding such techniques are not discussed herein. As the rechargeable storage device receives electricity, the rechargeable storage device stores the energy until it reaches a maximum capacity. Any energy stored in the rechargeable storage device is available for use by the signal conversion assembly 140 to receive the wireless audio signals and convert them into acoustical energy. As power is drawn from the rechargeable storage device, the rechargeable storage device becomes depleted and must receive electricity from an external source to store more energy.

The speaker 100 may employ an indicator, such as a light-emitting diode (LED), to signal when the rechargeable storage device has reached its maximum storage capacity or when the rechargeable storage device is being recharged. For example, the indicator may blink while the rechargeable storage device is being recharged and may turn off once maximum storage has been reached.

The speaker 100 may be used as an output device even when the rechargeable storage device is being recharged. In this case, in addition to delivering power to the rechargeable storage device, the electrical power assembly 130 also delivers power directly to the signal conversion assembly 140. As such, the rechargeable storage device is not discharged by operation of the speaker 100 when the electrical power assembly 130 has access to an external power source. In other words, the rechargeable storage device is only discharged when no other power source is available to the signal conversion assembly 140.

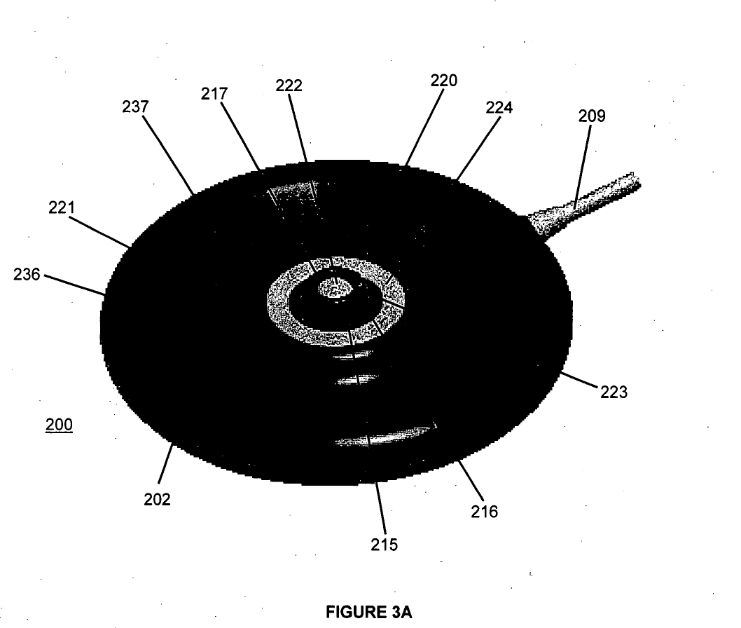

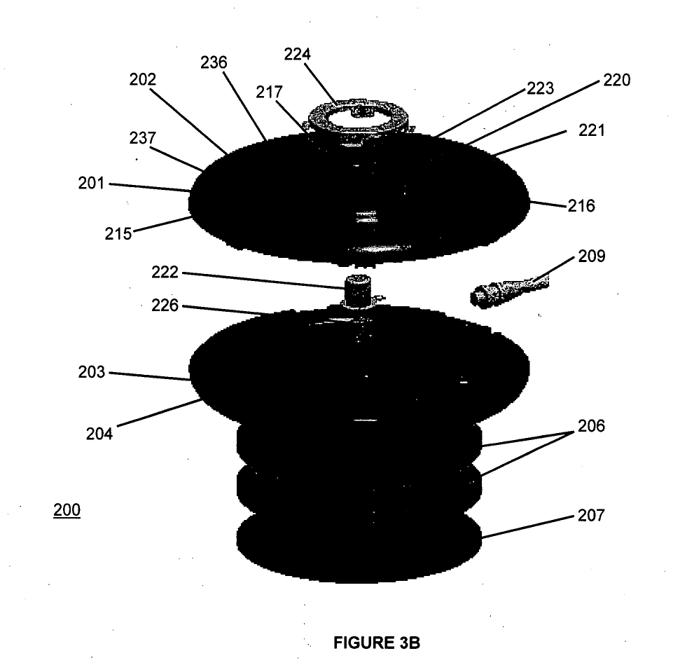

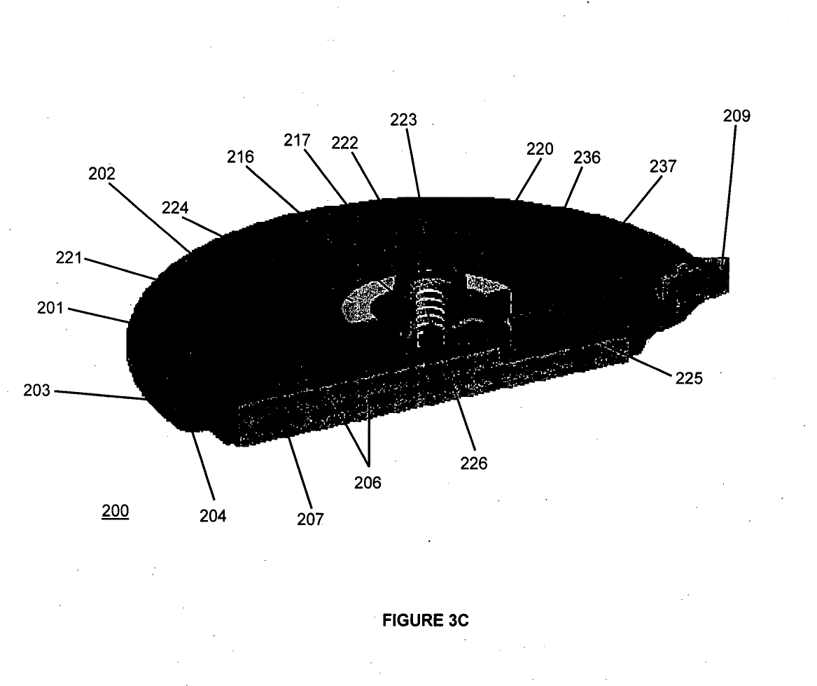

FIG. 3A illustrates a top view of the electrical power delivery base 200. The base top surface 202 engages the speaker bottom surface 104 when the speaker 100 is situated in the recharging position. The base top surface 202 is substantially circular, but may have other shapes. The base 200 has an electrical contact area 220 that is centrally positioned on the base top surface 202. The base 200 generally provides power to the speaker 100 through positive and negative electrical contacts, or terminals, which are arranged on the electrical contact area 220. As FIG. 3A shows further, a positive electrical terminal 222 is centrally positioned in the electrical contact area 220, and an annular, or ring-shaped, negative electrical terminal 224 positioned around the positive electrical terminal 222. In general, the annular negative electrical terminal 224 is positioned adjacent to the positive electrical terminal 222, which means that the annular negative electrical terminal 224 is not formed on the positive electrical terminal 222. As with the electrical contact area 120 for the speaker 100, it is understood that the arrangement of the positive and negative terminals are not limited to the arrangements described herein.

The electrical input 209, such as an electrical cord, delivers electricity from an external power source to the base 200. For instance, the electrical input 209 may be a part of a conventional AC/DC converter that is plugged into a conventional wall socket providing AC power and converts the AC power to DC power for use by the base 200. The cross-sectional view of FIG. 3C illustrates an interior cavity 210 of the base 200. The positive terminal (not shown) of the electrical cord 209 is connected to the positive electrical terminal 222 of the base 200, and the negative terminal (not shown) of the power input 209 is connected to the negative electrical terminal 224 of the base 200. The positive electrical terminal 222 of the base 200 is a substantially cylindrical body that extends upwardly through a channel 223 to the electrical contact area 220 from the base interior cavity 210. Similarly, the negative electrical terminal 224 is an annular body that extends upwardly to the electrical contact area 220 from a connection 225 to the negative terminal of the electrical cord 109 in the base interior 210.

FIG. 3B illustrates an exploded view of the electrical power delivery base 200. The base 200 includes a top cover 201 with the top surface 202, a bottom cover 203 with a bottom surface 204, fixed weights 206, and a silicone foot pad 207. When the top cover 201 and the bottom cover 203 are assembled together, they form the base interior cavity 210 in which the electrical connections for the base 200 are housed as shown in FIG. 3C. In particular, the base interior cavity 210 houses the connections described previously between the electrical input 209 and the positive and negative electrical terminals 222 and 224.

The use of a separate top cover 201 and bottom cover 203 facilitates manufacturing of the base 200 by allowing the interior of the base 200 to be accessible for incorporating the electrical connections into the base 200. The fixed weights 206 are attached to the bottom surface 204 of the bottom cover 203, and the silicone foot pad 207 forms the bottom of the base 200. The fixed weights 206 increase the overall weight of the base 200 to make the base 200 more difficult to displace. With the weights 206, the base 200 is positioned more stably on the supporting surface on which the base 200 sits. The silicone foot pad 207 also promotes stable positioning by increasing the frictional contact between the base 200 and the supporting surface, so that the base 200 can resist sliding on the supporting surface. Moreover, the silicone foot pad 207 protects both the base 200 and the supporting surface by minimizing abrasive contact between the base 200 and the supporting surface. The components of the base 200, i.e. the top cover 201, the bottom cover 203, the fixed weights 206, and the silicone foot pad 207, can be assembled to form the base 200, as shown in FIG. 3C, according to techniques that include, but are not limited to, the use of adhesives or bonding agents, interlocking pieces, fasteners, such as screws, or any combination thereof.

As discussed above, the base top surface 202 engages the speaker bottom surface 104 when the speaker 100 is situated in the recharging position as shown in FIG. 1. When the speaker 100 and the base 200 are engaged in this way, the positive electrical terminal 122 of the speaker 100, as shown in FIG. 4, is aligned with the positive electrical terminal 222 of the base 200 to establish an electrical connection therebetween. Similarly, the negative electrical terminal 124, as shown in FIG. 4, is aligned with the negative electrical terminal 224 to establish an electrical connection therebetween.

Accordingly, the positive electrical terminal 222 of the base 200 acts as a conductor between the positive terminal of the electrical input 209 and the positive electrical terminal 122 of the speaker 100. Similarly, the negative electrical terminal 224 acts as a conductor between the negative terminal of the electrical input 209 and the negative electrical terminal 124 of the speaker 100. In general, the current flows, in sequence, from the positive terminal of the electrical input 209, through the positive electrical terminal 222 of the base 200, through the positive electrical terminal 122 of the speaker 100, through the circuitry and electrical components of speaker 100, through the negative electrical terminal 124 of the speaker 100, through the negative electrical terminal 222 of the base 200, and then to the negative terminal of the electrical input 209. As described above, the circuitry and electrical components of the speaker 100 include the electrical power assembly 130 connected to the interior signal conversion assembly 140 as well as the rechargeable storage device. Thus, the speaker 100 receives the power required to recharge the rechargeable storage device and/or to permit the use of speaker 100 as an audio output device.

When the speaker 100 is not situated on the base 200, the top surface 202 and the electrical contact area 220 of the base 200 are generally exposed. To reduce the risk of accidental shock, a low potential drop (voltage) may be employed between the positive electrical terminal 222 and the negative electrical terminal 224 of the base 200. Furthermore, as shown in FIG. 3C, the positive electrical terminal 222 of the base 200 may be slightly recessed within a positioning element channel 223 in the positioning element 215, so that accidental contact with the positive electrical terminal 222 is less likely.

In order to establish the electrical connections between the terminals of the speaker 100 and the base 200, an exemplary embodiment employs structural guides to ensure proper alignment between the speaker 100 and the base 200. In particular, FIG. 3A illustrates a positioning element 215 that is positioned in the electrical contact area 220 at the center of the base top surface 202. The positioning element 215 is a projection that extends, or protrudes, upwardly from a supporting surface, i.e. the electrical contact area 220. The channel 223 passes through the center of the positioning element 215 so that the positive electrical terminal 222, which extends through the channel 223, is positioned in the center of the positioning element 215. The receiving cavity 115 of the speaker 100 receives the positioning element 215 through the cavity opening 117. The receiving cavity 115 has a shape that corresponds with the positioning element 215, so that the receiving cavity 115 can mate with the positioning element 215.

While the embodiments described herein may employ a positioning element 215 on the base 200 and the receiving cavity 115 on the speaker 100, it is understood that alternative embodiments may employ a positioning element on the speaker and a receiving cavity on the electrical power deliver base.

Referring again to FIG. 2A, the speaker receiving cavity 115 has inner wall 116, and the positioning element 215 has an outer wall 216 as shown in FIG. 3A. When the positioning element 215 is positioned in the speaker receiving cavity 115, the inner wall 116 of the speaker receiving cavity 115 is spaced closely to the outer wall 216 of the positioning element 215. A small tolerance δ, illustrated in FIG. 4, minimizes the amount of lateral movement of the speaker receiving cavity 115 and the speaker 100 with respect to the positioning element 215 and the base 200. The tolerance 6, however, still permits the positioning element 215 to be received into the speaker receiving cavity 115 with minimal frictional resistance. Moreover, the tolerance 6 may vary in magnitude along different positions between the positioning element 215 and the receiving cavity 115.

Thus, when the positioning element 215 is positioned in the speaker receiving cavity 115, the speaker 100 is positioned over the appropriate area of base 200 to permit electrical connections between the electrical terminals of the speaker 100 and the base 200. In particular, the speaker 100 is centered over the center of the base 200. Furthermore, the small tolerance 6 keeps the positioning element 215 from moving significantly within the receiving cavity 115, and thus, the speaker 100 does not move substantially away from its centered position on the base 200.

As shown in FIGS. 3A and 3C, the positioning element 215 is frustaconical or frustum-shaped, i.e. shaped like the base of a truncated cone. The positioning element 215 has a dimension D_{2A} where it meets the base top surface 202. On the other hand, the positioning element 215 has a dimension D_{2B} at a top 217 of the positioning element 215. As the positioning element 215 extends upwardly from the base top surface 202, the positioning element 215 generally tapers from D_{2A} to a smaller dimension D_{2B} at the top 217, i.e. D_{2A}≈D_{2B}+α where α is some length. The dimensions D_{X} described herein may to diameter or width.

Correspondingly, as shown in FIG. 2A, the inner wall 116 of the receiving cavity 115 also defines a frustaconical shape to allow mating between the receiving cavity 115 and the positioning element 215. The receiving cavity 115 has a dimension D_{1A} at the cavity opening 117 and a smaller dimension D_{1B} at the upper surface 119 of the receiving area 115. The receiving cavity 115 tapers from a dimension D_{1A} to a smaller a dimension D_{1B} as it extends into the speaker 100, i.e. D_{1A}≈D_{1B}+β where β is some length.

When the positioning element 215 is positioned within the receiving cavity 115, the top 217 of the positioning element 215 is proximate to an upper surface 119 of the receiving cavity 115, and the base top surface 202 is proximate to the cavity opening 117 of the receiving cavity 115. Due to the tolerance 6 described previously, the dimension D_{1A} of the cavity opening 117 is slightly larger than the dimension D_{2A} of the positioning element 215, i.e. D_{1A}≈D_{2A}+δ. In addition, the dimension D_{1B} of the receiving cavity 115 is slightly larger than dimension D_{2B} at the top 217 of the positioning element 215, i.e. D_{1B}≈D_{2B}+δ.

Advantageously, the frustaconical shapes of the positioning element 215 and the inner wall 116 of the receiving cavity 115 facilitate and guide the positioning of the receiving cavity 115 over the positioning element 215. As the positioning element 215 is moved into the receiving cavity 115, the top 217 of the positioning element 215 must first pass through the cavity opening 117 before moving into a position proximate to the upper surface 119 of the receiving cavity 115. Because D_{1A}≈D_{2A}+δ and D_{2A}≈D_{2B}+α, as shown previously, D_{1A}≈D_{2B}+δ+α. Due to the length α, using frustaconical shapes provides a relatively larger receiving cavity 115 for aligning the positioning element 215, as compared to the use of non-tapered shapes, such as cylinders. In other words, when situating the speaker 100 on the base 200, a user does not have to align the center of cavity opening 117 exactly with the center of the top 217 of the positioning element 215. A greater difference between the area of the cavity opening 117 and the top 217 allows the center of cavity opening 117 to be offset from the center of the top 217. Even with an offset, the cavity opening 117 receives the top 217 of positioning element 215. The positioning element 215 is then guided along the inner walls 116 into the receiving cavity 115.

With the frustaconical shapes described in the embodiment above, the area A_{F} of a circular cavity opening 117 with diameter D_{1A} in terms of the diameter D_{2B} for a circular top 217 for the positional element 215 is:

$$\begin{matrix}{A}_{F} ( {D}_{2 B} ) \approx ( π / 4 ) {( {D}_{2 B} + δ + α )}^{2} \\ \approx ( π / 4 ) ( {D}_{2 B}^{2} + 2 {D}_{2 B} δ + {δ}^{2} + {α}^{2} + 2 {D}_{2 B} α + 2 δ α )\end{matrix}$$

where the area of a circle is (π/4)*diameter². Subtracting the area for a circular top 217 for the positioning element 215 from A_{F}(D_{2B}) reveals how much allowance is provided to facilitate the alignment of positioning element 215 and the receiving cavity 115:

A_{F}(D_{2B})−(π/4)D_{2B}²≈(π/4)(2D_{2B}δ+δ²+α²+2D_{2B}α+2δα)

To illustrate the advantage further, if the shapes of a positioning element 215′ and a receiving body 115′ were not frustaconical, but were cylindrical, the dimensions D_{1A} and D_{1B} for the receiving cavity 115′ would be substantially equal, i.e. D_{1A}≈D_{1B}, and the dimensions D_{2A} and D_{2B} for the positioning element 215′ would also be substantially equal. As with frustaconical shapes, there is a tolerance 6 between the receiving cavity 115′ and the positioning element 215′, i.e. D_{1A}≈D_{1B}≈D_{2A}+δ≈D_{2B}+δ. Thus, using cylindrical shapes, the area A_{C}(D_{2B}) of the circular cavity opening 117′ with dimension D_{1A} in terms of the diameter D_{2B} for the circular top 217′ for the positioning element 215′ is:

$$\begin{matrix}{A}_{C} ( {D}_{2 B} ) \approx ( π / 4 ) {( {D}_{2 B} + δ )}^{2} \\ \approx ( π / 4 ) ( {D}_{2 B}^{2} + 2 {D}_{2 B} δ + {δ}^{2} )\end{matrix}$$

Accordingly, the difference between the area A_{F}(D_{2B}) using frustaconical shapes and the area A_{C}(D_{2B}) using cylindrical shapes, is:

A_{F}(D_{2B})−A_{C}(D_{2B})≈(π/4)(α²+2D_{2B}α+2δα)

This difference represents how much more allowance, or acceptable offset, is provided to facilitate the alignment of positioning element 115 and the receiving cavity 115, when frustaconical shapes are employed in place of cylindrical shapes. It is understood that the embodiments of the present invention are not limited to the use of frustaconical shapes, and indeed alternative embodiments may have a cylindrical positioning element and a cylindrical receiving cavity. Although the use of frustaconical shapes described herein provides particular advantages, it is understood that alternative embodiments do not have to employ shapes that have some type of circular profile. For instance, a tapered polygonal solid may be employed.

Additional structural guides may be employed in combination with the positioning element 215 and the receiving cavity 115. For instance, as shown in FIG. 3C, electrical contact area 220 of the base 200 may be a raised circular surface that extends upwardly from the rest of the top base surface 202. The sides 221 of the electrical contact area 220 may also form a shape that is similar to a frustum. As such, the speaker 100 may have a speaker bottom recess 132, as illustrated in FIG. 2A, which extends into the speaker bottom 105 and has a shape that corresponds with the raised electrical contact area 220. The speaker bottom recess 132 has inner walls 133. The electrical contact area 120 and the receiving cavity 115 of the speaker 100 are centrally positioned within the speaker bottom recess 132. Thus, when the speaker 100 is situated on the base 200, the electrical contact area 220 of the base 200, as shown in FIG. 4, is received into the speaker bottom recess 132 of the speaker 100. As the speaker recess bottom 132 receives the electrical contact area 220, an inner wall 133 of the speaker bottom recess 132 may engage the sides 221 of the electrical contact area 220 and guide the electrical contact area 220 of the base 200 further into the speaker bottom recess 132. This occurs in a manner similar to the guiding of positioning element 215 into the receiving cavity 115, as described previously. During the movement of the electrical contact area 220 of the base 200 into the speaker bottom recess 132, the receiving cavity 115 also receives the positioning element 215.

Once the speaker 100 is situated on the base 200, additional support for the position of the speaker 100 may be provided by a circular depression 236 formed by the portion of the base top surface 202 surrounding the electrical contact area 220, as shown in FIG. 3A. The sides 237 of the circular depression 236 accommodate and support the curved surface of the bottom 104 of the spherical speaker body 101, while the electrical contact area 220 is received into the speaker bottom recess 132.

Although the close tolerance δ between the receiving cavity 115 and the positioning element 215 minimizes relative lateral motion between the speaker 100 and the base 200, the shapes of the receiving cavity 115 and the positioning element 215 may permit relative rotation between the speaker 100 and the base 200. In particular, the tolerance δ between the receiving cavity 115 and the positioning element 215 minimizes any frictional resistance therebetween. In addition, the materials forming the receiving cavity 115 and the positioning element 215 may also minimize friction. Alternatively, in order to minimize friction, a ring made of silicone or similarly-propertied material may be affixed in the circular depression 236, affixed to the speaker bottom 104, or placed between the circular depression 236 and the speaker bottom 104. Thus, the inner wall 116 of the receiving cavity 115 rotates about the positioning element 115. As shown in FIG. 1, it is advantageous to permit the speaker 100 to be rotated with respect to the base 200 so that the speaker may be oriented to direct the sound transmitted through the grill 108 in a desired direction. Due to the fixed weights 206 and the resistant silicone foot pad 207 of the base 200 described previously, it is easier to rotationally reposition the speaker 100 rather than the base 200.

In order to permit the speaker 100 to occupy any relative rotational position with respect to the base 200, the electrical connections established between the speaker 100 and the base 200 are not dependent on the rotational orientation of the speaker 100 relative to the base 200. As FIG. 4 illustrates, the positive electrical terminal 122 and the positive electrical terminal 222 engage each other at a center about which the speaker 100 rotates relative to the base 200. Thus, when such relative rotation occurs, there is no relative lateral movement between the positive electrical terminal 122 of the speaker 100 and the positive electrical terminal 222 of the base 200, allowing the electrical terminals 122 and 222 to remain in contact. As described above, the positive electrical terminal 122 is centrally positioned within the receiving cavity 115. In addition, the positive electrical terminal 222 is positioned at the center of the positioning element 215. When the positioning element 215 is received into the receiving cavity 115, the positive electrical terminal 122 at the center of the receiving cavity 115 is aligned with the positive electrical terminal 222 at the center of the positioning element 215. As the speaker 100 and the receiving cavity 115 rotate over the positioning element 215, the positive electrical terminal 222 remains aligned with the positive electrical terminal 122.

In addition, the annular shape of the negative electrical terminal 224 of the base 200 allows the corresponding negative electrical terminals 124 of the speaker 100 to remain engaged with the negative electrical terminal 224 regardless of how the speaker 100 is rotationally oriented with respect to the base 200. In other words, when the speaker 100 rotates about the positioning element 215, the rotating negative electrical terminals 124 of the speaker 100 follow a path that coincides with the annular shape of the negative electrical terminal 224 of the base 200. As such, the negative electrical terminals 124 of the speaker 100 remain aligned over the negative electrical terminal 224. While a single negative electrical terminal 124 may be employed, the exemplary embodiment of FIG. 2A has a plurality of negative electrical terminals 124. The plurality of negative terminals 124 improves electrical contact and increases the total surface area for the flow of current. The negative electrical terminals 124 form contact points that protrude from, and are equally spaced along, the annular surface 118 on the speaker 100. The annular surface 118 of the speaker 100 has a radius and center that generally correspond with the radius and the center of the annular electrical terminal 222 of the base 200. The centers of the annular surface 118 and the annular electrical terminal 222 are substantially aligned, when the positioning element 215 is received into the receiving cavity 115. Moreover, the centers of the annular surface 118 of the speaker 100 and the annular electrical terminal 222 of the base 200 are aligned with the center of the receiving cavity 115 and the center of the positioning element 215. Thus, the positive terminals 122 and 222 remain engaged with each other and the negative terminals 124 and 224 remain simultaneously engaged with each other when the speaker 100 rotates over the positioning element 215.

While embodiments described herein may permit relative rotation between the speaker 100 and the base 200, it is understood that the positioning element 215 and the receiving cavity 115 may be shaped to prevent such relative rotation.

To promote sufficient contact between the positive terminals 122 and 222, a biasing mechanism may be employed to create a force that promotes contact between the positive terminals 122 and 222. As shown in FIGS. 3C and 4, a spring 226 may be employed to bias the positive electrical terminal 222 of the base 200 upwardly into contact with the positive electrical terminal 122 of the speaker 100. As shown in FIG. 4, in order to make contact with the positive electrical terminal 222 of the base 200, the positive electrical terminal 122 of the speaker 100 extends into the channel 223 which houses the positive electrical terminal 222 of the base 200. Of course, a spring may be employed with the positive electrical terminal 122 of the speaker 100 in place of, or in combination with, the spring 226.

Similarly, to promote sufficient contact between the negative electrical terminals 124 and 224, a biasing mechanism may be employed to create a force that promotes contact between the negative electrical terminals 124 and 224. As shown in FIG. 4, springs 126 may be employed to bias the negative electrical terminal 124 of the speaker 100 downwardly into contact with the negative electrical terminal 224 of the base 200. As shown in FIG. 2A, the negative electrical terminals 124 extend through, and protrude from, the annular surface 118. Of course, a spring may be employed with the negative electrical terminal 224 in place of, or in combination with, the springs 126.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

What is claimed is:

1. A speaker system, comprising:
a first device having a supporting surface, the first device comprising:
a positioning element that protrudes from the supporting surface and forms a distal end, the positioning element tapering from the supporting surface to a smaller dimension at the distal end; and
a first electrical contact adjacent to the positioning element; and
a second device comprising:
a cavity receiving the positioning element; and
a second electrical contact engaging the first electrical contact,
wherein one of the first device and the second device is a speaker.

2. The system according to claim 1, wherein the positioning element is substantially frustaconical.

3. The system according to claim 2, wherein an inner wall of the cavity defines a substantially frustaconical shape.

4. The system according to claim 1, further comprising a spring biasing the first electrical contact and the second electrical contact into engagement with one another.

5. The system according to claim 1, wherein the first electrical contact comprises an annular contact surface surrounding the positioning element.

6. The system according to claim 5, wherein the second electrical contact is biased by a spring into engagement with the annular contact surface.

7. The system according to claim 5, wherein the second contact comprises a circular arrangement of point contacts, the circular arrangement corresponding with the annular contact surface.

8. The system according to claim 7, wherein the contact points are each biased by a spring into engagement with the annular contact surface.

9. The system according to claim 7, wherein a positioning element center, a cavity center, an annular contact surface center, and a circular arrangement center are all substantially aligned with one another.

10. The system according to claim 1, wherein the first device and the second device are rotationally repositionable relative to one another.

11. The system according to claim 1, wherein the first device further comprises a raised surface on which the positioning element and the first electrical contact are positioned, and the second device further comprises a recess that receives the raised surface.

12. The system according to claim 1, wherein the first device further comprises a depression, the second device being received into the depression when the positioning element is received into the cavity.

13. The system according to claim 1, wherein the positioning element of the first device includes a third electrical contact, and the second device further comprises a fourth electrical contact engaging the third contact.

14. The system according to claim 13, further comprising a spring biasing the third electrical contact and the fourth electrical contact into engagement with one another.

15. The system according to claim 13, wherein the third electrical contact extends through a channel passing through the positioning element.

16. The system according to claim 13, wherein the first electrical contact and the second electrical contact are negative electrical terminals, and the third electrical contact and the fourth electrical contact are positive electrical terminals.

17. The system according to claim 1, wherein the speaker is rechargeable.

18. The system according to claim 1, wherein the speaker receives wireless audio signals.

19. The system according to claim 1, wherein the first electrical contact is positioned next to the positioning element.

20. A speaker system, comprising:
a first device having a supporting surface and a positioning element protruding from the supporting surface to form a distal end, the positioning element tapering to a smaller dimension at the distal end;
a second device including a cavity that receives the positioning element, the first and second device being rotationally repositionable relative to one another; and
an electrical connection created between the first device and the second device when the cavity receives the positioning element at more than one relative rotational position between the first device and the second device,
wherein one of the first device and the second device is a speaker.

21. The system according to claim 20, wherein the positioning element is substantially frustaconical.

22. The system according to claim 21, wherein an inner wall of the cavity defines a substantially frustaconical shape.

23. The system according to claim 20, wherein the electrical connection comprises:
a first electrical contact including an annular contact surface surrounding the positioning element on one of the first and second device; and
a second electrical contact positioned on the other of the first and second device and engaging the annular contact surface.

24. The system according to claim 23, further comprising a spring biasing the second electrical contact and the annular contact surface into engagement with one another.

25. The system according to claim 24, wherein the second electrical contact comprises a circular arrangement of point contacts, the circular arrangement corresponding with the annular contact surface.

26. The system according to claim 25, wherein the contact points are each biased by a spring into engagement with the annular contact surface.

27. The system according to claim 23, wherein the electrical connection further comprises:
a third electrical contact on one of the first and second device; and
a fourth electrical contact on the other of the first and second device, the fourth electrical contact engaging the third electrical contact.

28. The system according to claim 27, wherein the first device and the second device are rotationally repositionable by relative rotation about the positioning element, and the third electrical contact and the fourth electrical contact are aligned with the positioning element.

29. The system according to claim 27, further comprising a spring biasing the third electrical contact and the fourth electrical contact into engagement with one another.

30. The system according to claim 27, wherein the third electrical contact extends through a channel passing through the positioning element.

31. The system according to claim 20, wherein the speaker is rechargeable.

32. The system according to claim 20, wherein the speaker receives wireless audio signals.
